(19) United States
(12) Patent Application Publication
(10) Pub. No.: US 2025/0307762 A1
(43) Pub. Date: Oct. 2, 2025

(54) METHOD AND APPARATUS FOR WAREHOUSING TASK EXECUTION

(71) Applicant: Shanghai Gewu Zhiyuan Network Technology Co., Ltd., Shanghai (CN)

(72) Inventor: Liang Ding, Beijing (CN)

(21) Appl. No.: 18/974,324

(22) Filed: Dec. 9, 2024

(30) Foreign Application Priority Data
Mar. 28, 2024 (CN) 202410372682.2

(51) Int. Cl. G06Q 10/087

(52) U.S. Cl. CPC G06Q 10/087

(57) ABSTRACT

A method for warehouse task execution comprises receiving a task information set sent by a cloud server, wherein the task information includes task information of a plurality of target warehousing tasks of the target warehouse depend on, and the target warehousing task is a warehousing task with estimated execution time satisfying a preconfigured condition; storing the task information set in a preconfigured storage space of the terminal device; in response to receiving a task execution instruction indicating an execution of a first warehousing task and the preconfigured storage space comprising the task information that the first warehousing task depends on, obtaining, from the preconfigured storage space, the task information that the first warehousing task depends on; and executing the first warehousing task based on the task information that the first warehousing task depends on.

### CROSS-REFERENCE

This application claims priority to Chinese patent application No. 202410372682.2, entitled “METHOD AND APPARATUS FOR WAREHOUSING TASK EXECUTION” filed on Mar. 28, 2024, the entire contents of which are incorporated herein by reference.

### FIELD

The disclosure relates to the field of warehouse management technologies, in particular, to a method and device for warehousing task execution.

### BACKGROUND

As warehouse management has higher and higher requirements for large-scale operation efficiency of warehouse management, the degree of automation of warehouse operations is also increasing. Automated equipment and Internet of Things related functions are increasingly replacing manual operations.

In a traditional warehouse management architecture, when executing warehousing task processing, terminal devices deployed in a warehouse often need to rely on the task information obtained in real time from a cloud server. However, such a warehouse management architecture is difficult to ensure the efficiency of terminal devices in processing warehousing tasks in high-throughput scenarios. For example, in the scenario of cargo collection and transfer warehouse operation, packages from all over a country need to undergo sorting operations, and the shipping labels are changed from first-stage labels (with the destination address being the transit center) to second-stage labels (with the destination address being the final delivery address). Because this step involves batch processing with high throughput requirements, if each package requires to retrieve the second-stage shipping label from the cloud server, the delay in obtaining the second-stage shipping labels from the cloud server would significantly affect the efficiency of the sorting operations.

### SUMMARY

In view of this, embodiments of the disclosure provide a method and an apparatus for warehousing task execution, to reduce or avoid obtaining task information in real time from a cloud server, thereby improving execution efficiency of warehousing tasks.

To achieve the foregoing objective, an embodiment of the disclosure provides a technical solution as follow.

According to a first aspect, an embodiment of the disclosure provides a method for warehousing task execution, applied to a terminal device deployed in a target warehouse, the method includes:
receiving a task information set sent by a cloud server, wherein the task information includes task information of a plurality of target warehousing tasks of the target warehouse depend on, and the target warehousing task is a warehousing task with estimated execution time satisfying a preconfigured condition;
storing the task information set in a preconfigured storage space of the terminal device;
in response to receiving a task execution instruction indicating an execution of a first warehousing task and the preconfigured storage space comprising the task information that the first warehousing task depends on, obtaining, from the preconfigured storage space, the task information that the first warehousing task depends on;
executing the first warehousing task based on the task information that the first warehousing task depends on.

In an optional implementation of the embodiments of the disclosure, the method further includes: sending the task information set to at least one other device deployed in the target warehouse.

As an optional implementation of the embodiments of the disclosure, the method further includes:
in response to receiving a task execution instruction indicating an execution of a second warehousing task and the preconfigured storage space fails to include the task information that the second warehousing task depends on, sending a task information request to the cloud server, wherein the task information request is configured to obtain the task information that the second warehousing task depends on;
receiving the task information that the second warehousing task depends on sent by the cloud server;
executing the second warehousing task based on the task information that the second warehousing task depends on.

As an optional implementation of the embodiments of the disclosure, the method further includes:

after executing the first warehousing task based on the task information that the first warehousing task depends on, sending first indication information to the cloud server, wherein the first indication information is configured to indicate that execution of the first warehousing task is completed;
receiving an information invalidation instruction sent by the cloud server;
in response to the information invalidation instruction, deleting, from the preconfigured storage space, the task information that the first warehousing task depends on.

As an optional implementation of the embodiments of the disclosure, the method further includes:
receiving second indication information sent by the cloud server, wherein the second indication information is configured to indicate to a change in a third warehousing task;
in response to the second indication information, updating the task information that the third warehousing task depends on in the preconfigured storage space.

According to a second aspect, an embodiment of the disclosure provides a method for warehousing task execution, applied to a cloud server, where the method includes:
determining an estimated execution time of each warehousing task of a target warehouse;
combining task information that at least one target warehousing task depends on, to generate task information set, the at least one target warehousing task having the estimated execution time satisfying a preconfigured condition.
sending the task information set to a terminal device deployed in the target warehouse, to cause the terminal device to store the task information set in a preconfigured storage space of the terminal device, and in response to receiving a task execution instruction indicating an execution of a first warehousing task and the preconfigured storage space comprising the task information that the first warehousing task depends on, obtain the task information that the first warehousing task depends on from the preconfigured storage space.

As an optional implementation of the embodiments of the disclosure, determining the estimated execution time of a respective warehousing task of the target warehouse includes:
obtaining the estimated execution time of the respective warehousing task according to the task information of the respective warehousing task and a prediction model;
wherein the prediction model is a model obtained by training a preconfigured machine learning model based on sample data, and the sample data includes the task information of a plurality of sample warehousing tasks and the actual execution time of each sample warehousing task.

As an optional implementation of the embodiments of the disclosure, the method further includes:
receiving a task information request sent by the terminal device, wherein the task information request is configured to obtain the task information that the second warehousing task depends on;
sending the task information that the second warehousing task depends on to the terminal device, causing the terminal device to execute the second warehousing task based on the task information that the second warehousing task depends on.

As an optional implementation of the embodiments of the disclosure, the method further includes:
receiving first indication information sent by the terminal device, wherein the first indication information is configured to indicate that execution of the first warehousing task is completed;
sending an information invalidation instruction to the terminal device, to cause the terminal device to delete the task information that the first warehousing task depends on from the preconfigured storage space in response to the information invalidation instruction.

As an optional implementation of the embodiments of the disclosure, the method further includes:
send to the terminal device, second indication information indicating to a change in a third warehousing task, to cause the terminal device to update the task information that the third warehousing task depends on in the preconfigured storage space in response to the second indication information.

According to a third aspect, an embodiment of the disclosure provides a terminal device, comprising:
a transceiver unit, configured to receive a task information set sent by a cloud server, wherein the task information set includes the task information that a plurality of target warehousing tasks of the target warehouse depends on, and the target warehousing task is a warehousing task with an estimated execution time satisfying a preconfigured condition;
a storage unit, configured to store the task information set in a preconfigured storage space of the terminal device; and
a processing unit, configured to obtain, from the preconfigured storage space, the task information that a first warehousing task depends on in response to receiving a task execution instruction indicating an execution of the first warehousing task and the preconfigured storage space includes the task information that the first warehousing task depends on;
an execution unit, configured to execute the first warehousing task based on the task information that the first warehousing task depends on.

As an optional implementation of the embodiments of the disclosure,
the processing unit is further configured to: in response to receiving a task execution instruction indicating an execution of a second warehousing task and the preconfigured storage space fails to include the task information that the second warehousing task depends on, send a task information request to the cloud server, wherein the task information request is configured to obtain the task information that the second warehousing task depends on; and receive the task information that the second warehousing task depends on sent by the cloud server;
the execution unit is further configured to execute the second warehousing task based on the task information that the second warehousing task depends on.

In an optional implementation of the embodiments of the disclosure, the execution unit is further configured to after executing the first warehousing task based on the task information that the first warehousing task depends on, send first indication information to the cloud server, wherein the first indication information is configured to indicate that execution of the first warehousing task is completed;
the transceiver unit is further configured to receive an information invalidation instruction sent by the cloud server;
the storage unit is further configured to in response to the information invalidation instruction, delete, from the preconfigured storage space, the task information that the first warehousing task depends on.

In an optional implementation of the embodiments of the disclosure, the transceiver unit is further configured to receive second indication information sent by the cloud server, wherein the second indication information is configured to indicate to a change in a third warehousing task;
the storage unit is further configured to in response to the second indication information, update the task information that the third warehousing task depends on in the preconfigured storage space.

According to a fourth aspect, an embodiment of the disclosure provides a cloud server, comprising:
a processing unit, configured to determine an estimated execution time of a respective warehousing task of a target warehouse;
a generating unit, configured to combine task information that at least one target warehousing task depends on, to generate a task information set, the at least one target warehousing task having the estimated execution time satisfying a preconfigured condition.
a transceiver unit, configured to send the task information set to a terminal device deployed in the target warehouse, to cause the terminal device to store the task information set in a preconfigured storage space of the terminal device, and in response to receiving a task execution instruction indicating an execution of a first warehousing task and the preconfigured storage space comprising the task information that the first warehousing task depends on, obtain the task information that the first warehousing task depends on from the preconfigured storage space.

As an optional implementation of the embodiments of the disclosure, the processing unit is specifically configured to obtain the estimated execution time of the respective warehousing task according to the task information of the respective warehousing task and a prediction model;
the prediction model is a model obtained by training a preconfigured machine learning model based on sample data, and the sample data includes the task information of a plurality of sample warehousing tasks and the actual execution time of each sample warehousing task.

As an optional implementation of the embodiments of the disclosure,
the transceiver unit is further configured to receive a task information request sent by the terminal device, wherein the task information request is configured to obtain the task information that the second warehousing task depends on, and send the task information that the second warehousing task depends on to the terminal device, causing the terminal device to execute the second warehousing task based on the task information that the second warehousing task depends on.

As an optional implementation of the embodiments of the disclosure,
the transceiver unit is further configured to receive first indication information sent by the terminal device, wherein the first indication information is configured to indicate that execution of the first warehousing task is completed, and send an information invalidation instruction to the terminal device, to cause the terminal device to delete the task information that the first warehousing task depends on from the preconfigured storage space in response to the information invalidation instruction.

As an optional implementation of the embodiments of the disclosure,
the transceiver unit is further configured to send to the terminal device, second indication information indicating to a change in a third warehousing task, to cause the terminal device to update the task information that the third warehousing task depends on in the preconfigured storage space in response to the second indication information.

According to a fifth aspect, an embodiment of the disclosure provides an electronic device, comprising a memory and a processor, where the memory is configured to store a computer program, and the processor is configured to, when executing the computer program, cause the electronic device to implement the method for warehousing task execution according to any one of the foregoing implementations.

According to a sixth aspect, an embodiment of the disclosure provides a computer-readable storage medium, where when the computer program is executed by a computing device, causes the computing device to implement the foregoing method for warehousing task execution.

According to a seventh aspect, an embodiment of the disclosure provides a computer program product, when the computer program product running on a computer, causes the computer to implement the foregoing method for warehousing task execution.

The method for warehousing task execution provided by the embodiment of the disclosure includes the following steps: firstly, receiving a task information set sent by a cloud server, wherein the task information includes task information of a plurality of target warehousing tasks of the target warehouse depend on, and the target warehousing task is a warehousing task with estimated execution time satisfying a preconfigured condition, and storing the task information set in a preconfigured storage space of the terminal device; in response to receiving a task execution instruction indicating an execution of a first warehousing task and the preconfigured storage space comprising the task information that the first warehousing task depends on, obtaining, from the preconfigured storage space, the task information that the first warehousing task depends on; and executing the first warehousing task based on the task information that the first warehousing task depends on. According to the method for warehousing task execution provided in the embodiments of the disclosure, the task information on which the warehousing task with estimated execution time satisfying the preconfigured condition depend is stored into the preconfigured storage space of the terminal device, and the task information that the first warehousing task depends on is obtained from the preconfigured storage space, in response to receiving a task execution instruction indicating an execution of a first warehousing task and the preconfigured storage space comprising the task information that the first warehousing task depends on, and the first warehousing task based on the task information that the first warehousing task depends on is executed, the method for warehousing task execution provided in the embodiments of the disclosure may reduce or avoid obtaining the task information that the warehousing task depends on from the cloud server in real time, thereby improving the execution efficiency of the warehousing task.

### BRIEF DESCRIPTION OF DRAWINGS

The drawings herein are incorporated in and constitute a part of this description and illustrate embodiments consistent with the disclosure and together with the description to explain the principles of the disclosure.

In order to more clearly illustrate the technical solutions in the embodiments of the disclosure or in the prior art, the accompanying drawings that need to be invoked in the embodiments or the prior art descriptions are briefly introduced below, and it is obvious to those skilled in the art that other drawings may be obtained based on these drawings without creative labor.

FIG. 1 is a schematic structural diagram of a cloud server according to an embodiment of the disclosure;

FIG. 2 is a schematic structural diagram of a client device according to an embodiment of the disclosure;

FIG. 3 is a first interaction flowchart of a method for warehousing task execution according to an embodiment of the disclosure;

FIG. 4 is a second interaction flowchart of a method for warehousing task execution according to an embodiment of the disclosure;

FIG. 5 is a first schematic diagram of a communication mode according to an embodiment of the disclosure;

FIG. 6 is a second schematic diagram of a communication mode according to an embodiment of the disclosure;

FIG. 7 is a schematic diagram of a modeling process of a failure prediction model according to an embodiment of the disclosure;

FIG. 8 is a schematic structural diagram of a terminal device according to an embodiment of the disclosure;

FIG. 9 is a schematic structural diagram of a cloud server according to an embodiment of the disclosure;

FIG. 10 is a schematic diagram of a hardware structure of an electronic device according to an embodiment of the disclosure.

### DETAILED DESCRIPTION

For a clearer understanding of the foregoing objectives, features, and advantages of the disclosure, the solutions of the disclosure are further described below. It should be noted that, in the absence of conflict, the features in the embodiments and embodiments of the disclosure may be combined with each other.

Many specific details are set forth in the following description to facilitate a thorough understanding of the present disclosure, but the present disclosure may also be implemented in other manners different from those described herein, and the embodiments in the specification are only a part of the embodiments of the disclosure and are not all of the embodiments.

In embodiments of the disclosure, wordings such as “example” or “for example” are used to indicate an example, a description, or an illustration. Any embodiment or design described as “example” or “for example” in the embodiments of the present disclosure should not be construed as more preferred or advantageous than other embodiments or designs. Rather, the terms “example” or “for example” are invoked to present relevant concepts in a specific manner. In addition, in the description of the embodiments of the disclosure, unless otherwise specified, “a plurality of” means two or more.

The method for warehousing task execution provided in embodiments of the disclosure is applied to a warehousing management architecture. a warehousing management architecture in some embodiments of the disclosure is first describes below. The warehouse management architecture provided by the embodiment of the disclosure includes a cloud server deployed in a cloud and a terminal device deployed in the warehouse.

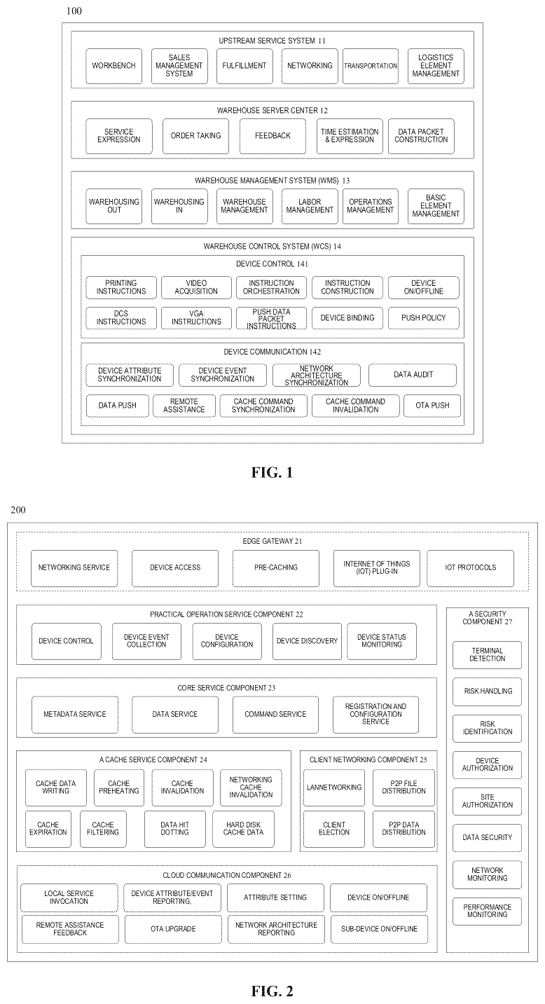

As shown in FIG. 1, the cloud server 100 includes an upstream service system 11, a warehouse server center 12, a warehouse management system (WMS) 13, and a warehouse control system (WCS) 14. The upstream service system 11 mainly includes components for implementing the following functions: workbench, sales management system, fulfillment, networking, transportation, logistics element management, and the like. The warehouse server center 12 mainly includes components for implementing the following functions: service expression, order taking, feedback, time estimation & expression, and data packet construction. The warehouse management system 13 mainly includes components for implementing the following functions: warehousing out, warehousing in, warehouse management, labor management, operations management, basic element management, and the like. The warehouse control system 14 mainly includes two components, one is the device control 141, and the other is the device communication 142. The device control 141 mainly includes components for implementing the following functions: printing instructions, video acquisition, instruction orchestration, instruction construction, device on/offline, distributed control system (DCS) instructions, automated guided vehicle (VGA) instructions, push data packet instructions, device binding, and push policy. The device communication 142 mainly includes components for implementing the following functions: device attribute synchronization, device event synchronization, data packet push, network architecture synchronization, data audit, cache command synchronization, cache command invalidation, remote assistance, and over the air push. In embodiments of the disclosure, the cloud server 100 is mainly configured to send a task information set including task information on which a plurality of warehousing tasks depend to the terminal device 200 in response to a cache update request, and send task information of corresponding warehousing task to the terminal device 200 in response to a task information request.

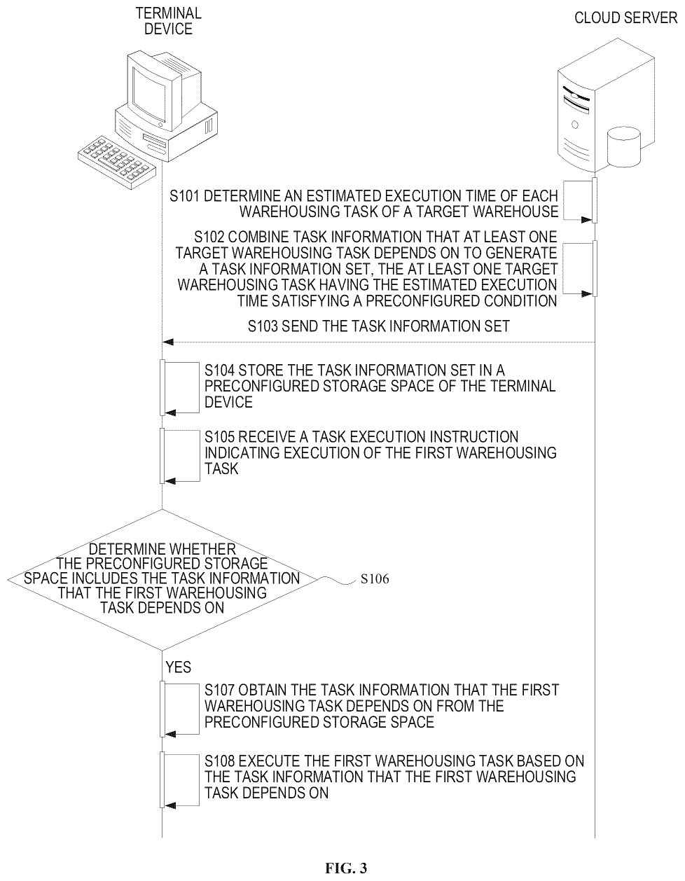

As shown in FIG. 2, the terminal device 200 may include an edge gateway 21, a practical operation service component 22, a core service component 23, a cache service component 24, a client networking component 25, a cloud communication component 26, and a security component 27. The edge gateway 21 is configured to provide edge services for the local area network, and the edge gateway 21 is included only when the edge server is included. The edge gateway 21 mainly includes components for implementing the following functions: networking service, device access, pre-caching, Internet of Things (IoT) plug-in, IoT protocols, and the like. The practical operation service component 22 is mainly configured to provide specific practical device capabilities, and includes components for implementing the following functions: device control, device event collection, device configuration, device discovery, device status monitoring, and the like. The core service component 23 mainly includes components for implementing the following functions: metadata service, data service, command service, registration and configuration service, and the like. The cache service component 24 mainly includes components for implementing the following functions: cache data writing, cache preheating, cache invalidation, networking cache invalidation, cache expiration, cache filtering, data hit dotting, and hard disk cache data. The client networking mainly includes components for implementing the following functions: local area network networking, P2P file distribution, client election, and P2P data distribution. The cloud communication 26 mainly includes components for implementing the following functions: local service invocation, device attribute/event reporting, attribute setting, device on/offline, remote assistance feedback, OTA upgrade, network architecture reporting, and sub-device on/offline. The security component 27 mainly includes components for implementing the following functions: terminal detection, risk handling, risk identification, device authorization, site authorization, data security, network monitoring, performance monitoring, and the like.

It should be noted that, in the warehouse management architecture, the cloud server may provide services for a plurality of terminal devices deployed in different warehouses. Terminal devices deployed in the same warehouse may be one or more. If there are a plurality of terminal devices deployed in the same warehouse, the plurality of terminal devices deployed in the same warehouse may access the same local area network. and if one of the plurality of terminal device obtains the task information set, it may further send the task information set to other terminal devices in the same local area network through P2P communication. The terminal device may be a personal computer, a handheld computer, a Web workstation, a VGA robot, an edge server, or the like.

An embodiment of the disclosure provides a method of warehousing task execution, as shown in FIG. 3, and the method for warehousing task execution includes the following steps:
S101: The cloud server determines an estimated execution time of each warehousing task of a target warehouse.

In embodiments of the disclosure, the estimated execution time of the warehousing task is the estimated time for executing the warehousing task. For example, if a certain warehouse task is expected to be executed within 24 hours, it may then be determined that the estimated execution time of the warehouse task is within 24 hours.

In some embodiments, the warehousing task may include: warehousing in, in-warehouse management, warehousing out, cross docking (transferring goods directly from the incoming platform to the outgoing platform), and the like, which is not limited in the embodiments of the disclosure.

As described above, in the warehouse management architecture, the cloud server may provide services (push task information sets) to a plurality of terminal devices deployed in different warehouses at the same time. Therefore, the cloud server may unitize metadata such as goods, inventory, documents, spaces, tasks, containers, labor and the like of each warehouse, and push the task information set corresponding to each warehouse to the terminal devices deployed in each warehouse using a mirroring technology. The mirroring technology refers to mirroring the storage spaces of two devices using software or other special network devices, so that storage content of the storage spaces of the two devices is consistent.
S102: The cloud server combines task information that at least one target warehousing task depends on to generate a task information set, the at least one target warehousing task having the estimated execution time satisfying a preconfigured condition.

In some embodiments, the preconfigured condition may be that the estimated execution time is less than or equal to a threshold duration. For example, the task information on which the warehousing tasks with estimated execution time less than or equal to 12 hours depend is combined into the task information set. For another example, the task information on which the warehousing tasks with estimated execution time less than or equal to 24 hours depend is combined into the task information set. For another example, the task information on which the warehousing out tasks that need to be executed on the same day or the next day depend, or the task information on which the warehousing out tasks that need to be executed on the same day is combined into the task information set.
S103: The cloud server sends the task information set to a terminal device deployed in the target warehouse.

Correspondingly, receiving the task information set sent by the cloud server.

The task information set includes task information on which a plurality of target warehousing tasks of the target warehouse depend, and the target warehousing task is a warehousing task with estimated execution time satisfies a preconfigured condition.

In some embodiments, sending, by the cloud server, the task information set to the terminal device deployed in the target warehouse includes: actively pushing, by the cloud server, the task information set to the terminal device deployed in the target warehouse. For example, the cloud server obtains the estimated execution times of respective warehousing tasks of the target warehouse periodically using a preconfigured duration as a period, combines the task information on which the target warehousing task with the execution time satisfying a preconfigured condition depends, generates the task information set, and sends the task information set to the terminal device deployed in the target warehouse.

In some other embodiments, sending, by the cloud server, the task information set to the terminal device deployed in the target warehouse includes: sending the task information set to the terminal device in response to an information request sent by the terminal device deployed in the target warehouse.

In embodiments of the disclosure, the cloud server and the terminal device may communicate in a communication manner such as a Web Socket, a Message Queuing Telemetry Transport (MQTT), a Hypertext Transfer Protocol (HTTP), a Transmission Control Protocol (TCP) long connection, and the like.
S104: The terminal device stores the task information set in a preconfigured storage space of the terminal device.

The preconfigured storage space in embodiments of the disclosure may be a cache, a memory, a hard disk, or the like of the terminal device, which is not limited in embodiments of the disclosure, and the preconfigured storage space may store the task information set.

In some embodiments, storing the task information set in the preconfigured storage space of the terminal device includes directly writing the task information set into the preconfigured storage space of the terminal device. For example, when executing the warehouse task of replacing shipping labels, when scanning first-stage label information, it is necessary to retrieve the second-stage shipping label information, therefore, the task information on which the warehousing task depends is the second-stage shipping label information, then the second-stage shipping label information may be directly written into the preconfigured storage space.

In some embodiments, storing the task information set in the preconfigured storage space of the terminal device includes preprocessing respective piece of the task information in the task information set and then writing the respective piece of the task information into the preconfigured storage space of the terminal device. For example, in the process of executing an AGV sorting task, it is necessary to move the sorting object from the current storage address to the storage address corresponding to the sorting category. Therefore, the storage address corresponding to the sorting category is taken as the destination for path planning, and the corresponding sorting path is generated, and the sorting path is stored in the preconfigured storage space.

As described above, a plurality of terminal devices may be deployed in the same warehouse and access the same local area network. If there are a plurality of terminal devices deployed in the target warehouse, the terminal device in embodiments of the disclosure may be any terminal device of the plurality of terminal devices. After receiving the task information set sent by the cloud server, the terminal device may further synchronize the task information set to other terminal devices in the local area network through the local area network.
S105: The terminal device receives a task execution instruction indicating execution of the first warehousing task.
S106: Determine whether the preconfigured storage space includes the task information that the first warehousing task depends on.

In the above step S106, if the preconfigured storage space includes the task information that the first warehousing task depends on, the following step S107 is executed:
S107: the terminal device obtains the task information that the first warehousing task depends on from the preconfigured storage space.
S108: The terminal device executes the first warehousing task based on the task information that the first warehousing task depends on.

The method for warehousing task execution provided by the embodiment of the disclosure includes the following steps: firstly, receiving a task information set sent by a cloud server, wherein the task information includes task information of a plurality of target warehousing tasks of the target warehouse depend on, and the target warehousing task is a warehousing task with estimated execution time satisfying a preconfigured condition, and storing the task information set in a preconfigured storage space of the terminal device; in response to receiving a task execution instruction indicating an execution of a first warehousing task and the preconfigured storage space comprising the task information that the first warehousing task depends on, obtaining, from the preconfigured storage space, the task information that the first warehousing task depends on; and executing the first warehousing task based on the task information that the first warehousing task depends on. According to the method for warehousing task execution provided in the embodiments of the disclosure, the task information on which the warehousing task with estimated execution time satisfying the preconfigured condition depend is stored into the preconfigured storage space of the terminal device, and the task information that the first warehousing task depends on is obtained from the preconfigured storage space, in response to receiving a task execution instruction indicating an execution of a first warehousing task and the preconfigured storage space comprising the task information that the first warehousing task depends on, and the first warehousing task based on the task information that the first warehousing task depends on is executed, the method for warehousing task execution provided in the embodiments of the disclosure may reduce or avoid obtaining the task information that the warehousing task depends on from the cloud server in real time, thereby improving the execution efficiency of the warehousing task.

In some embodiments, the method for warehousing task execution provided in the foregoing embodiment further includes:
the terminal device sends the task information set to at least one other device deployed in the target warehouse.

In some embodiments, the at least one other device and the terminal device are connected to each other using a local area network, and the terminal device sends the task information set to the at least one other device through a local area network.

In some embodiments, the terminal device sends the task information set to the at least one other device through a Peer-to-Peer network.

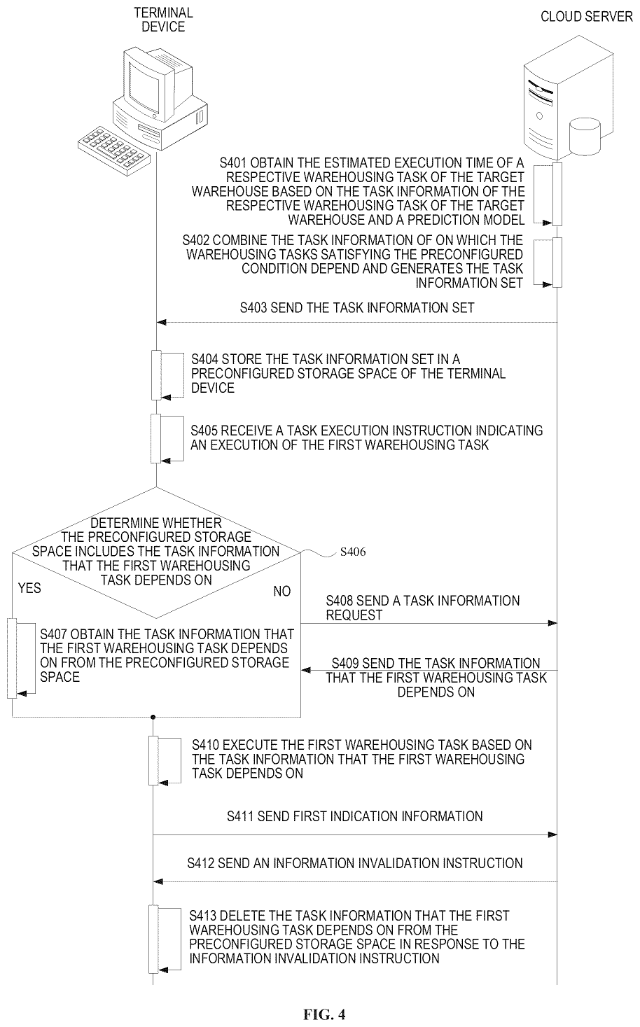

As an extension and refinement of the foregoing embodiment, an embodiment of the disclosure provides another method for warehousing task execution, as shown in FIG. 4, the method for warehousing task execution includes the following steps:
S401: The cloud server obtains the estimated execution time of a respective warehousing task of the target warehouse based on the task information of the respective warehousing task of the target warehouse and a prediction model.

The prediction model is a model obtained by training a preconfigured machine learning model based on sample data, and the sample data includes the task information of a plurality of sample warehousing tasks and the actual execution time of each sample warehousing task.

The preconfigured machine learning model in embodiments of the disclosure may include: a linear regression model, a logistic regression model, a decision tree model, a convolutional neural network model, a recurrent neural network, and the like, which is not limited in embodiments of the disclosure.

Referring to FIG. 5, in some embodiments, a process of performing failure modeling on a warehousing task may include the following steps S51 to S54:
S51: obtaining an original data set.

The original data set may include the task information such as a warehouse task execution node, a transportation trajectory, and a terminal trajectory, and the actual task execution time data corresponding to the warehouse task.

S52: performing data cleaning on the data in the original data set.

The data cleaning on the data in the original data set includes extracting text from the original data set, obtaining information such as time, city and site, performing natural language processing (NLP) and format standardization on the extracted text, and finally removing abnormal data such as address anomalies, un-updated information, abnormal status, delivery timeout and the like.
S53: performing statistical model estimation based on the cleaned data.

That is, the execution time of the task is estimated, and the accuracy and delay rate of the estimated task execution time are statistically calculated based on the expected execution time and the actual execution time, as well as the weighted calculation of the indicators that affect the task execution time.
S54: performing line integration tree model evaluation based on the spatial dimension, the indicator dimension, the time dimension, the attribute dimension, and the statistical dimension.

The spatial dimension includes information such as province, city, district, county and the like, the indicator dimension includes information such as the number of tasks, transportation duration, trajectory node, and delivery site, the time dimension includes information such as duration, time granularity, holiday, and the like, and the attribute dimension includes information such as source destination, logistics provider, and various levels of nodes, and the statistical dimension includes information such as total number, average value, median, 75% distribution, maximum value, minimum value, data deviation from the mean, data deviation from the minimum value, and standard deviation.
S402: The cloud server combines the task information of on which the warehousing tasks satisfying the preconfigured condition depend and generates the task information set.
S403: The cloud server sends the task information set to the terminal device.

Correspondingly, the terminal device receives the task information set sent by the cloud server.

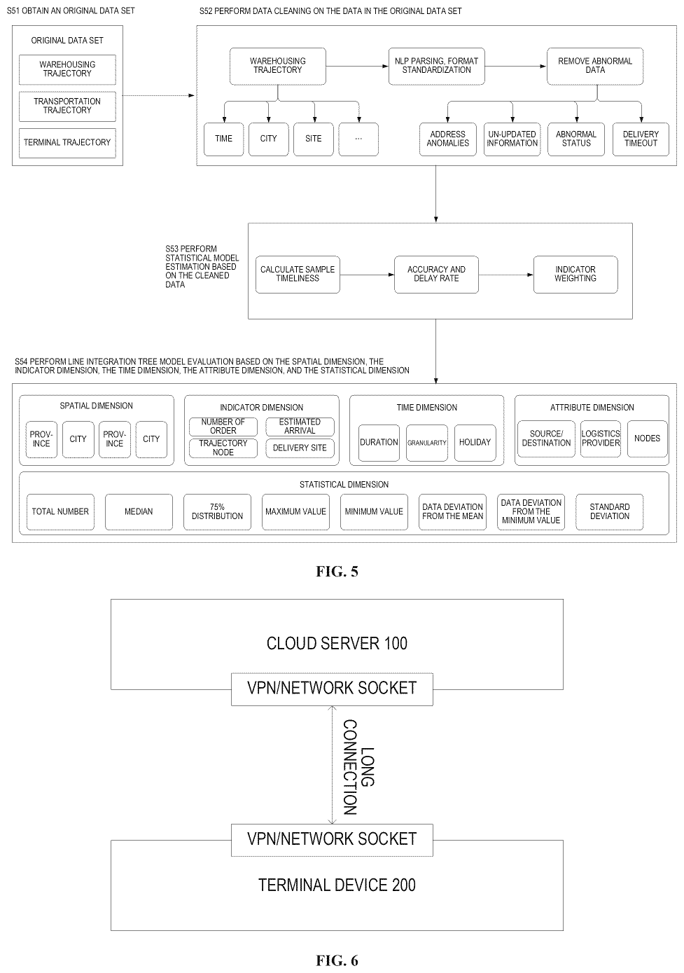

In some embodiments, referring to FIG. 6, the cloud server 100 and the terminal device 200 may communicate by establishing a long connection through a virtual private network (VPN) or a network socket.

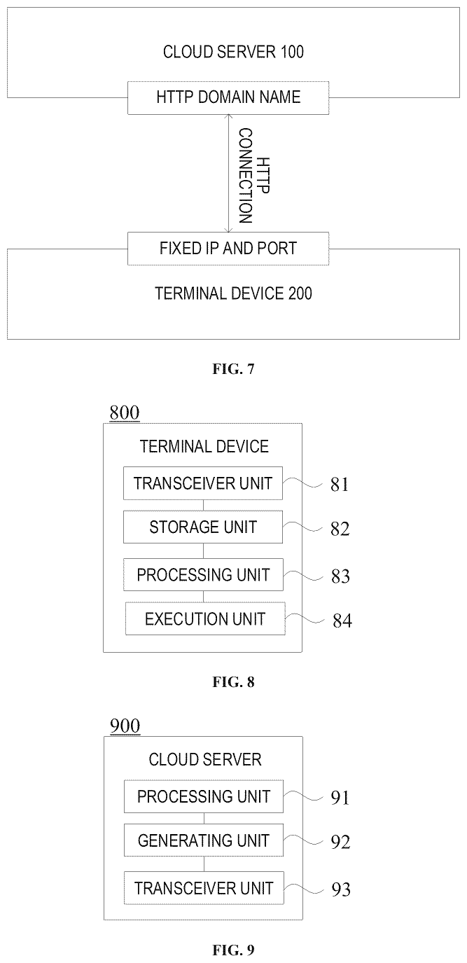

In some embodiments, as shown in FIG. 7, the cloud server 100 and the terminal device 200 may be mapped to the terminal device 200 using a broadband service with a fixed IP, and the cloud server 100 and the terminal device 200 form a peer-to-peer cluster, and the cloud server 100 and the terminal device 200 expose the HTTP service through the public network to implement remote invocation.
S404: The terminal device stores the task information set in a preconfigured storage space of the terminal device.
S405: The terminal device receives a task execution instruction indicating an execution of the first warehousing task.
S406: The terminal device determines whether the preconfigured storage space includes the task information that the first warehousing task depends on.

In the above step S406, if the preconfigured storage space includes the task information that the first warehousing task depends on, the following step S407 is executed:
S407: the terminal device obtains the task information that the first warehousing task depends on from the preconfigured storage space.

In the above step S406, if the cache of the terminal device fails to include the task information that the first warehousing task depends on, the following steps S408 and S409 are executed:
S408: the terminal device sends a task information request to the cloud server.

Correspondingly, the cloud server receives the task information request sent by the terminal device.

The task information request is configured to obtain task information that the first warehousing task depends on.
S409: The cloud server sends the task information that the first warehousing task depends on to the terminal device.

Correspondingly, the terminal device receives the task information that the first warehousing task depends on sent by the cloud server.

After the task information that the first warehousing task depends on is obtained using the foregoing step S407 or the task information that the first warehousing task depends on is obtained using the foregoing steps S408 and S409, the following steps are executed.
S410: The terminal device executes the first warehousing task based on the task information that the first warehousing task depends on.
S411: The terminal device sends first indication information to the cloud server.

Correspondingly, the cloud server receives the first indication information sent by the terminal device.

The first indication information indicates that execution of the first warehousing task is completed.
S412: The cloud server sends an information invalidation instruction to the terminal device.

Correspondingly, the terminal device receives the information invalidation instruction sent by the cloud server.
S413: The terminal device deletes the task information that the first warehousing task depends on from the preconfigured storage space in response to the information invalidation instruction.

In some embodiments, the method for warehousing task execution provided in embodiments of the disclosure further includes:
the cloud server sends second indication information to the terminal device, where the second indication information indicates a change in a third warehousing task, to cause the terminal device to update, in response to the second indication information, the task information that the third warehousing task depends on in the preconfigured storage space.

Correspondingly, the terminal device receives the second indication information sent by the cloud server, and updates, in response to the second indication information, task information that the third warehousing task depends on in the preconfigured storage space.

For example, in a logistics distribution scenario, if the recipient initiates a return during the package transportation process, the cloud server may send the second indication information to the terminal device, and after receiving the second indication information sent by the cloud server, the delivery address of the corresponding package may be modified from the address provided by the original recipient to the sending address of the package.

It should be further noted that, because the method for warehousing task execution provided in the foregoing embodiment may store the task information set obtained from the cloud server into the preconfigured storage space of the terminal device, and in response to receiving the task execution instruction indicating an execution of the first warehousing task and the preconfigured storage space including the task information that the first warehousing task depends on, obtain the task information that the first warehousing task depends on from the cache of the terminal device, and execute the first warehousing task based on the task information that the first warehousing task depends on, therefore, in a weak network environment, the terminal device may also execute the warehousing task based on the task information stored in the preconfigured storage space, thereby ensuring that the performance efficiency is not affected by the broken network or the high delay.

Based on the same inventive concept, as an implementation of the foregoing method, an embodiment of the disclosure further provides a terminal device and a cloud server, where the embodiments correspond to the foregoing method embodiments, and for ease of reading, details of the foregoing method embodiments are not described herein again in embodiments, but it should be clear that the terminal device and the cloud server in embodiments can correspondingly implement the entire content in the foregoing method embodiments.

An embodiment of the disclosure provides a terminal device, and FIG. 8 is a schematic structural diagram of the terminal device, and as shown in FIG. 8, the terminal device 800 includes:
a transceiver unit 81 is configured to receive a task information set sent by a cloud server, wherein the task information set comprises the task information that a plurality of target warehousing tasks of the target warehouse depends on, and the target warehousing task is a warehousing task with an estimated execution time satisfying a preconfigured condition;
a storage unit 82 is configured to store the task information set in a preconfigured storage space of the terminal device;
a processing unit 83 is configured to, obtain, from the preconfigured storage space, the task information that a first warehousing task depends on in response to receiving a task execution instruction indicating an execution of the first warehousing task and the preconfigured storage space comprises the task information that the first warehousing task depends on;
an execution unit 84 is configured to execute the first warehousing task based on the task information that the first warehousing task depends on.

As an optional implementation of the embodiments of the disclosure,
the processing unit 83 is further configured to: in response to receiving a task execution instruction indicating an execution of a second warehousing task and the preconfigured storage space fails to include the task information that the second warehousing task depends on, send a task information request to the cloud server, wherein the task information request is configured to obtain the task information that the second warehousing task depends on; and receive the task information that the second warehousing task depends on sent by the cloud server;
the execution unit 84 is further configured to execute the second warehousing task based on the task information that the second warehousing task depends on.

In an optional implementation of the embodiments of the disclosure, the execution unit 84 is further configured to after executing the first warehousing task based on the task information that the first warehousing task depends on, send first indication information to the cloud server, wherein the first indication information is configured to indicate that execution of the first warehousing task is completed;
the transceiver unit 81 is further configured to receive an information invalidation instruction sent by the cloud server;
the storage unit 82 is further configured to in response to the information invalidation instruction, delete, from the preconfigured storage space, the task information that the first warehousing task depends on.

In an optional implementation of the embodiments of the disclosure, the transceiver unit 81 is further configured to receive second indication information sent by the cloud server, wherein the second indication information is configured to indicate to a change in a third warehousing task;
the storage unit 82 is further configured to in response to the second indication information, update the task information that the third warehousing task depends on in the preconfigured storage space.

The terminal device provided in embodiments of the disclosure may execute the method for warehousing task execution provided in the foregoing embodiments, and implementation principles and technical effects thereof are similar, and details are not described herein again.

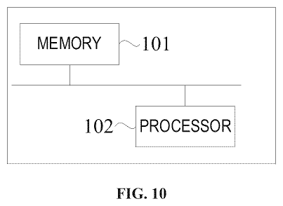

An embodiment of the disclosure provides a cloud server, FIG. 9 is a schematic structural diagram of the cloud server, and as shown in FIG. 9, the processing unit 91 includes:
a processing unit 91 is configured to determine an estimated execution time of a respective warehousing task of a target warehouse;
a generating unit 92 is configured to combine task information that at least one target warehousing task depends on, to generate a task information set, the at least one target warehousing task having the estimated execution time satisfying a preconfigured condition;
a transceiver unit 93 is configured to send the task information set to a terminal device deployed in the target warehouse, to cause the terminal device to store the task information set in a preconfigured storage space of the terminal device, and in response to receiving a task execution instruction indicating an execution of a first warehousing task and the preconfigured storage space comprising the task information that the first warehousing task depends on, obtain the task information that the first warehousing task depends on from the preconfigured storage space.

As an optional implementation of the embodiments of the disclosure, the processing unit 91 is specifically configured to obtain the estimated execution time of the respective warehousing task according to the task information of the respective warehousing task and a prediction model;
the prediction model is a model obtained by training a preconfigured machine learning model based on sample data, and the sample data includes the task information of a plurality of sample warehousing tasks and the actual execution time of each sample warehousing task.

As an optional implementation of the embodiments of the disclosure,
the transceiver unit 93 is further configured to receive a task information request sent by the terminal device, where the task information request is used to request to obtain task information that the second warehousing task depends on, and task information that is of the second warehousing task and that is sent to the terminal device, so that the terminal device executes the second warehousing task based on task information that the second warehousing task depends on.

As an optional implementation manner of the embodiments of the disclosure,

The transceiver unit 93 is further configured to receive a task information request sent by the terminal device, wherein the task information request is configured to obtain the task information that the second warehousing task depends on, and send the task information that the second warehousing task depends on to the terminal device, causing the terminal device to execute the second warehousing task based on the task information that the second warehousing task depends on.

As an optional implementation of the embodiments of the disclosure,
the transceiver unit 93 is further configured to send to the terminal device, second indication information indicating to a change in a third warehousing task, to cause the terminal device to update the task information that the third warehousing task depends on in the preconfigured storage space in response to the second indication information.
the cloud server provided in embodiments of the disclosure may execute the method for warehousing task execution provided in the foregoing embodiments, and implementation principles and technical effects thereof are similar, and details are not described herein again.

Based on the same inventive concept, an embodiment of the disclosure further provides an electronic device. FIG. 10 is a schematic structural diagram of an electronic device according to an embodiment of the disclosure. As shown in FIG. 10, the electronic device provided in embodiments includes: a memory 101 and a processor 102, where the memory 101 is configured to store a computer program, when executing the computer program, cause the electronic device to implement the method for warehousing task execution according to any one of the foregoing implementations.

Based on the same inventive concept, an embodiment of the disclosure further provides a computer-readable storage medium, where when the computer program is executed by a computing device, causes the computing device to implement the foregoing method for warehousing task execution.

Based on the same inventive concept, an embodiment of the disclosure further provides a computer program product, when the computer program product running on a computer, causes the computer to implement the foregoing method for warehousing task execution.

Those skilled in the art should understand that the embodiments of the present disclosure may be provided as a method, a system, or a computer program product. Thus, the present disclosure may take the form of an entire hardware, full software, or combining software and hardware aspects. Moreover, the present disclosure may take the form of a computer program product embodied on one or more computer-usable storage media having computer-usable program code embodied therein.

The processor may be a central processing unit (CPU), or may be another general purpose processor, a digital signal processor (DSP), an application specific integrated circuit (ASIC), a field programmable gate array (FPGA) or another programmable logic device, a discrete gate or transistor logic device, a discrete hardware component, or the like. The general purpose processor may be a microprocessor or the processor may be any conventional processor or the like.

The memory may include non-persistent memory in a computer-readable medium, random access memory (RAM), and/or non-volatile memory, such as read-only memory (ROM) or flash RAM. The memory is an example of a computer-readable medium.

Computer-readable media include permanent and non-permanent, removable and non-removable storage media. The storage medium may be implemented by any method or technique, which may be computer-readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disc read-only memory (CD-ROM), digital versatile disc (DVD) or other optical storage, magnetic cassettes, magnetic disk storage or other magnetic storage devices, or any other non- transmission medium, which can be used to store information that can be accessed by a computing device. According to the definitions herein, computer-readable media do not include transitory media, such as modulated data signals and carriers.

Finally, it should be noted that the foregoing embodiments are only used to illustrate the technical solutions of the disclosure, but not to limit the foregoing embodiments, although the present disclosure has been described in detail with reference to the foregoing embodiments, those skilled in the art should understand that the technical solutions described in the foregoing embodiments may still be modified, or some or all of the technical features may be equivalently replaced, and these modifications or replacements are not made to depart from the scope of the technical solutions in the embodiments of the disclosure.

I/we claim:

1. A method of warehousing task execution, applied to a terminal device deployed in a target warehouse, the method comprising:
receiving a task information set sent by a cloud server, wherein the task information comprises task information of a plurality of target warehousing tasks of the target warehouse depend on, and the target warehousing task is a warehousing task with estimated execution time satisfying a preconfigured condition;
storing the task information set in a preconfigured storage space of the terminal device;
in response to receiving a task execution instruction indicating an execution of a first warehousing task and the preconfigured storage space comprising the task information that the first warehousing task depends on, obtaining, from the preconfigured storage space, the task information that the first warehousing task depends on;
executing the first warehousing task based on the task information that the first warehousing task depends on.

2. The method of claim 1, further comprising:
sending the task information set to at least one other device deployed in the target warehouse;
and/or,
in response to receiving a task execution instruction indicating an execution of a second warehousing task and the preconfigured storage space fails to comprise the task information that the second warehousing task depends on, sending a task information request to the cloud server, wherein the task information request is configured to obtain the task information that the second warehousing task depends on;
receiving the task information that the second warehousing task depends on sent by the cloud server;
executing the second warehousing task based on the task information that the second warehousing task depends on.

3. The method of claim 1, further comprising:
after executing the first warehousing task based on the task information that the first warehousing task depends on, sending first indication information to the cloud server, wherein the first indication information is configured to indicate that execution of the first warehousing task is completed;
receiving an information invalidation instruction sent by the cloud server;
in response to the information invalidation instruction, deleting, from the preconfigured storage space, the task information that the first warehousing task depends on.

4. The method of claim 1, further comprising:
receiving second indication information sent by the cloud server, wherein the second indication information is configured to indicate to a change in a third warehousing task;
in response to the second indication information, updating the task information that the third warehousing task depends on in the preconfigured storage space.

5. The method of claim 1, wherein the warehousing task is to replace a shipping label, and the task information is the second-stage shipping label information.

6. The method of claim 1, wherein the warehousing task is an automated guiding vehicle (AGV) sorting task, the method further comprises:
generating a sorting path based on a storage address and a sorting category of a target object; and
storing the sorting path in the preconfigured storage space.

7. The method of claim 6, wherein the storage address corresponding to the sorting category of the target object is taken as a destination for the sorting path.

8. A method for warehousing task execution, applied to a cloud server, the method comprising:
determining an estimated execution time of each warehousing task of a target warehouse;
combining task information that at least one target warehousing task depends on, to generate task information set, the at least one target warehousing task having the estimated execution time satisfying a preconfigured condition;
sending the task information set to a terminal device deployed in the target warehouse, to cause the terminal device to store the task information set in a preconfigured storage space of the terminal device, and in response to receiving a task execution instruction indicating an execution of a first warehousing task and the preconfigured storage space comprising the task information that the first warehousing task depends on, obtain the task information that the first warehousing task depends on from the preconfigured storage space.

9. The method of claim 8, wherein determining the estimated execution time of a respective warehousing task of the target warehouse comprises:
obtaining the estimated execution time of the respective warehousing task according to the task information of the respective warehousing task and a prediction model;
wherein the prediction model is a model obtained by training a preconfigured machine learning model based on sample data, and the sample data comprises the task information of a plurality of sample warehousing tasks and the actual execution time of each sample warehousing task.

10. The method of claim 8, further comprising:
receiving a task information request sent by the terminal device, wherein the task information request is configured to obtain the task information that the second warehousing task depends on;
sending the task information that the second warehousing task depends on to the terminal device, causing the terminal device to execute the second warehousing task based on the task information that the second warehousing task depends on.

11. The method of claim 8, further comprising:
receiving first indication information sent by the terminal device, wherein the first indication information is configured to indicate that execution of the first warehousing task is completed;
sending an information invalidation instruction to the terminal device, to cause the terminal device to delete the task information that the first warehousing task depends on from the preconfigured storage space in response to the information invalidation instruction.

12. The method according to claim 8, further comprising:
send to the terminal device, second indication information indicating to a change in a third warehousing task, to cause the terminal device to update the task information that the third warehousing task depends on in the preconfigured storage space in response to the second indication information.

13. An electronic device, comprising: a memory and a processor, wherein the memory is configured to store a computer program, and the processor is configured to, when executing the computer program, cause the electronic device to implement a method for warehousing task execution, comprising:
receiving a task information set sent by a cloud server, wherein the task information comprises task information of a plurality of target warehousing tasks of the target warehouse depend on, and the target warehousing task is a warehousing task with estimated execution time satisfying a preconfigured condition;
storing the task information set in a preconfigured storage space of the terminal device;
in response to receiving a task execution instruction indicating an execution of a first warehousing task and the preconfigured storage space comprising the task information that the first warehousing task depends on, obtaining, from the preconfigured storage space, the task information that the first warehousing task depends on;
executing the first warehousing task based on the task information that the first warehousing task depends on.

14. The electronic device of claim 13, the method further comprising:
sending the task information set to at least one other device deployed in the target warehouse;
and/or,
in response to receiving a task execution instruction indicating an execution of a second warehousing task and the preconfigured storage space fails to comprise the task information that the second warehousing task depends on, sending a task information request to the cloud server, wherein the task information request is configured to obtain the task information that the second warehousing task depends on;
receiving the task information that the second warehousing task depends on sent by the cloud server;
executing the second warehousing task based on the task information that the second warehousing task depends on.

15. The electronic device of claim 13, the method further comprising:
after executing the first warehousing task based on the task information that the first warehousing task depends on, sending first indication information to the cloud server, wherein the first indication information is configured to indicate that execution of the first warehousing task is completed;
receiving an information invalidation instruction sent by the cloud server;
in response to the information invalidation instruction, deleting, from the preconfigured storage space, the task information that the first warehousing task depends on.

16. The electronic device of claim 13, the method further comprising:
receiving second indication information sent by the cloud server, wherein the second indication information is configured to indicate to a change in a third warehousing task;
in response to the second indication information, updating the task information that the third warehousing task depends on in the preconfigured storage space.

17. The electronic device of claim 13, wherein the warehousing task is to replace a shipping label, and the task information is the second-stage shipping label information.

18. The electronic device of claim 13, wherein the warehousing task is an automated guiding vehicle (AGV) sorting task, the method further comprises:
generating a sorting path based on a storage address and a sorting category of a target object; and
storing the sorting path in the preconfigured storage space.

19. The electronic device of claim 18, wherein the storage address corresponding to the sorting category of the target object is taken as a destination for the sorting path.
